(19) United States
(12) Patent Application Publication
(10) Pub. No.: US 2025/0232893 A1
(43) Pub. Date: Jul. 17, 2025

(54) ROUTING STRUCTURE OF WIRE HARNESS

(71) Applicant: YAZAKI CORPORATION, Tokyo (JP)

(72) Inventors: Katsunori Sato, Makinohara-shi (JP); Tatsuya Oga, Makinohara-shi (JP); Mariko Nakagawa, Makinohara-shi (JP)

(21) Appl. No.: 19/002,751

(22) Filed: Dec. 27, 2024

(30) Foreign Application Priority Data
Jan. 15, 2024 (JP) 2024-003684

(51) Int. Cl. H01B 7/00

(52) U.S. Cl. CPC H01B 7/0045

(57) ABSTRACT

A routing structure of a wire harness includes a wire harness including a detection wire connecting a bus bar and a connector; and a protector; in which the wire harness includes a protecting portion protected by the protector, a first exposed portion, and a second exposed portion, the first exposed portion projects out from the protector toward the bus bar, the second exposed portion projects out from the protector toward the connector, and the protector is configured to accommodate the protecting portion so as to extend the first exposed portion and the second exposed portion side by side, and to change a distance between the first exposed portion and the second exposed portion.

### CROSS-REFERENCE TO RELATED APPLICATION(S)

The present application claims priority to and incorporates by reference the entire contents of Japanese Patent Application No. 2024-003684 filed in Japan on Jan. 15, 2024.

### BACKGROUND OF THE INVENTION

### 1. Field of the Invention

The present invention relates to a routing structure of a wire harness.

### 2. Description of the Related Art

Conventionally, there is a technique of connecting a connector connected to a wire harness to a mating connector. Japanese Patent Application Laid-open No. 2020-021595 discloses a circuit body with a connector including a circuit body configured by a flexible substrate provided with a wiring pattern and a connector attached to the circuit body.

It is desirable that the workability of the work of fitting the connector connected to the wire harness to the mating connector can be improved. For example, in a configuration in which the wire harness is protected by a protector, if a change in the shape of the wire harness or a change in a routing path is allowed, the workability of the fitting work can be improved.

### SUMMARY OF THE INVENTION

An object of the present invention is to provide a routing structure of a wire harness capable of improving the workability of a fitting work.

A routing structure of a wire harness according to one aspect of the invention includes a wire harness including a detection wire connecting a bus bar and a connector; and a protector, wherein the wire harness includes a protecting portion protected by the protector, a first exposed portion, and a second exposed portion, the first exposed portion projects out from the protector toward the bus bar, the second exposed portion projects out from the protector toward the connector, and the protector is configured to accommodate the protecting portion so as to extend the first exposed portion and the second exposed portion side by side, and to change a distance between the first exposed portion and the second exposed portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view of a routing structure of a wire harness according to an embodiment;

FIG. 2 is a plan view of the routing structure of the wire harness according to the embodiment;

FIG. 3 is a perspective view of the routing structure of the wire harness according to the embodiment;

FIG. 4 is an exploded perspective view of the routing structure of the wire harness according to the embodiment;

FIG. 5 is an exploded perspective view of the routing structure of the wire harness according to the embodiment; and

FIG. 6 is a view for explaining deformation of a bent portion.

### DETAILED DESCRIPTION OF THE PREFERRED EMBODIMENT

Hereinafter, a routing structure of a wire harness according to an embodiment of the present invention will be described in detail with reference to the drawings. Note that the present invention is not limited by the embodiment. In addition, constituent elements in the following embodiment include those that can be easily assumed by those skilled in the art or those that are substantially the same.

### EMBODIMENT

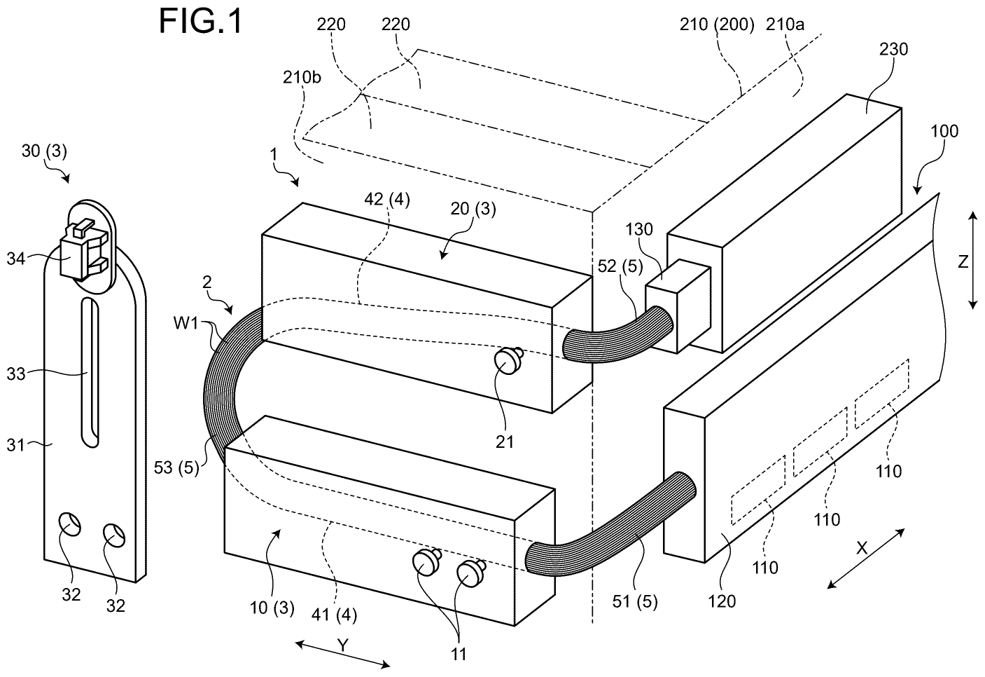

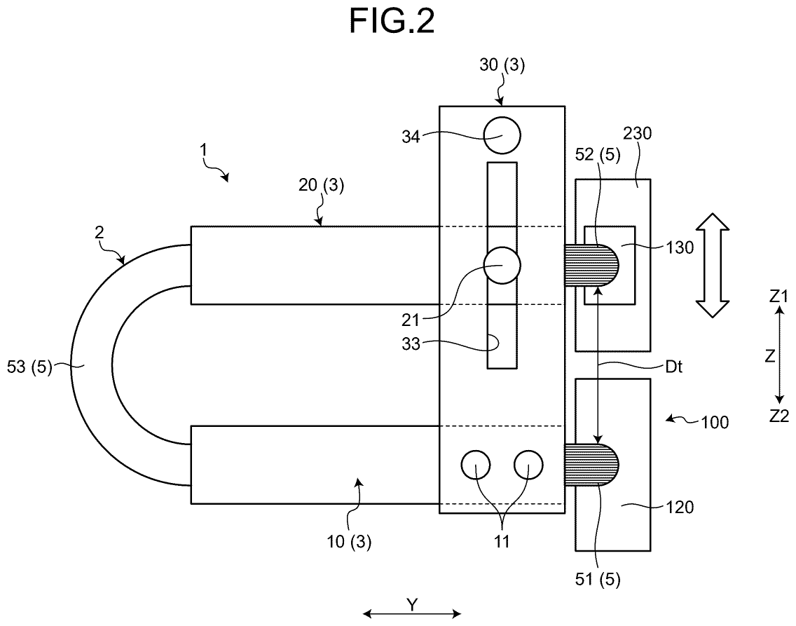

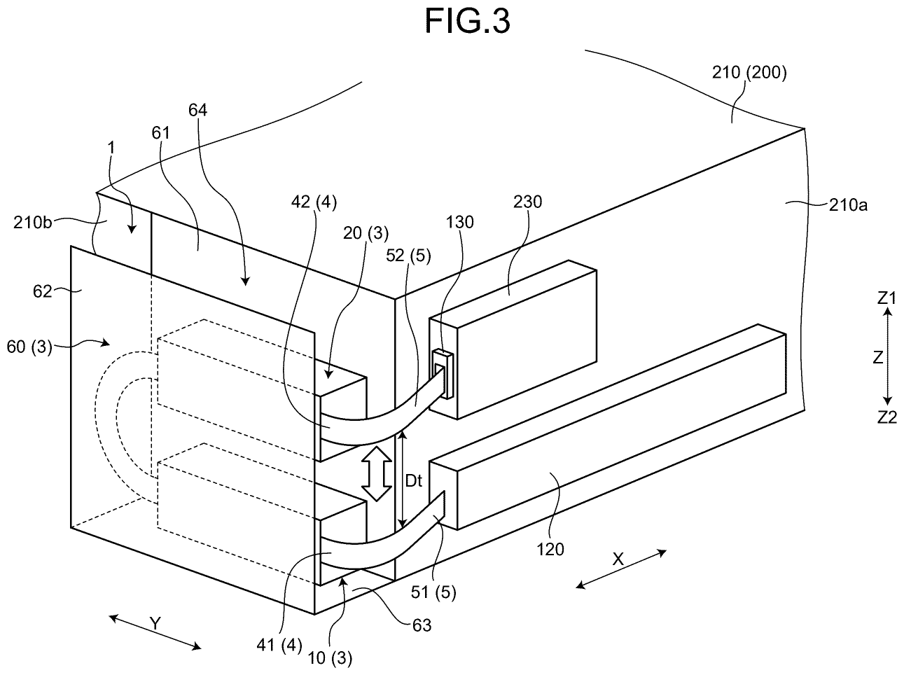

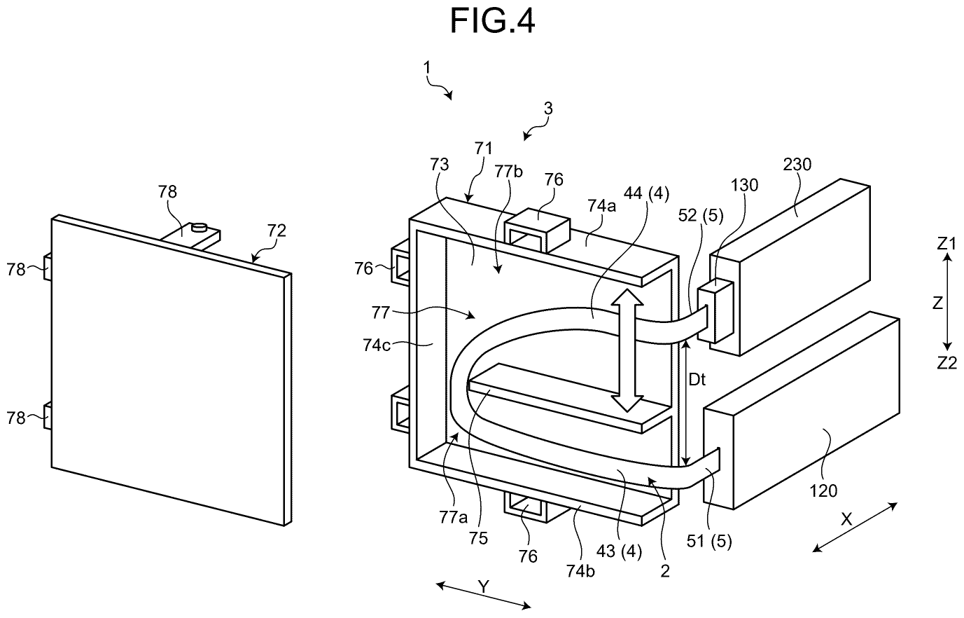

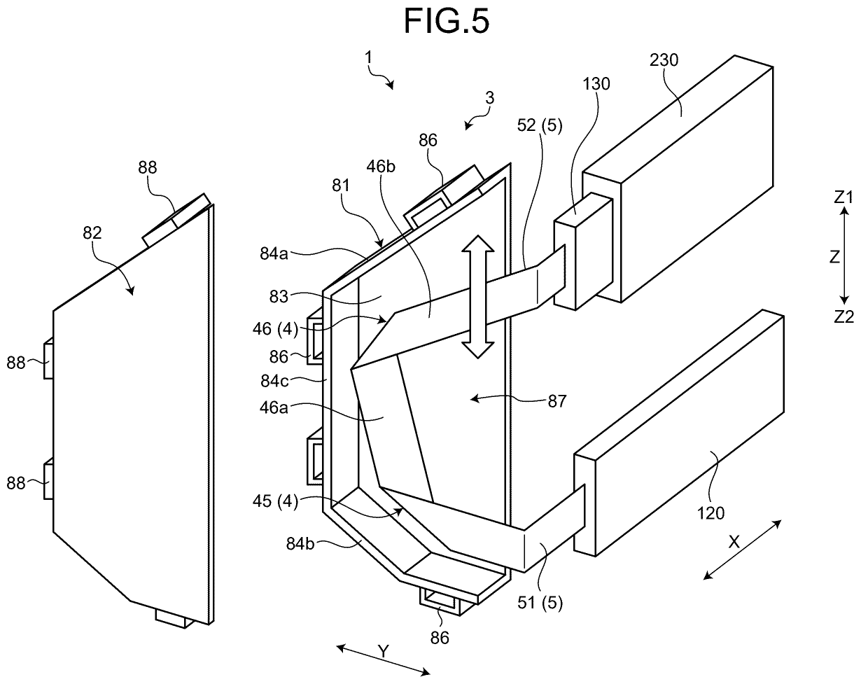

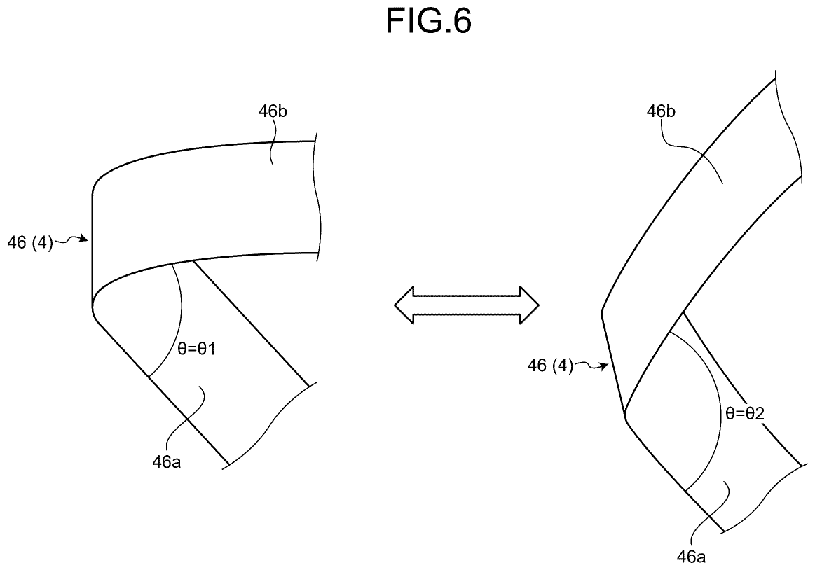

An embodiment will be described with reference to FIGS. 1 to 6. The present embodiment relates to a routing structure of a wire harness. FIG. 1 is an exploded perspective view of a routing structure of a wire harness according to an embodiment, FIG. 2 is a plan view of the routing structure of the wire harness according to the embodiment, FIG. 3 is a perspective view of the routing structure of the wire harness according to the embodiment, FIGS. 4 and 5 are exploded perspective views of the routing structure of the wire harness according to the embodiment, and FIG. 6 is a view for explaining deformation of a bent portion.

As illustrated in FIG. 1, a routing structure 1 of a wire harness according to an embodiment includes a wire harness 2 and a protector 3. The wire harness 2 connects the plurality of bus bars 110 and a connector 130. The routing structure 1 of the wire harness is applied to, for example, a battery pack 200 having a battery module 210. In this case, the wire harness 2 can be used as an element of the busbar module 100.

The battery module 210 includes a plurality of battery cells 220. The plurality of battery cells 220 are arranged side by side along a first direction X. The busbar module 100 includes a plurality of bus bars 110, a case 120, a wire harness 2, a connector 130, and a protector 3. The bus bar 110 can be connected to an electrode of the battery cell 220. The bus bar 110 connects, for example, electrodes of two adjacent battery cells 220.

A case 120 accommodates the plurality of bus bars 110 and a part of the wire harness 2. The case 120 is molded using, for example, synthetic resin having insulating property. The case 120 includes a holding portion that holds the bus bar 110. The plurality of bus bars 110 are held side by side in a first direction X by the case 120. The case 120 is fixed to a first surface 210a of a battery module 210 while holding the plurality of bus bars 110. The first surface 210a is a surface on which the electrode of the battery cell 220 is disposed, and is, for example, a side surface of the battery module 210.

The wire harness 2 is, for example, an electric wire bundle having a plurality of electric wires. The electric wire of the wire harness 2 is, for example, a sheathed electric wire having a core wire and an insulating layer covering the core wire. The wire harness 2 is routed from the case 120 to the connector 130. The wire harness 2 may have a tubular exterior member that accommodates a plurality of electric wires. The exterior member can suppress separation of a plurality of electric wires and interference of peripheral components with the electric wires. The plurality of electric wires include a detection wire W1 connected to the bus bar 110. When the busbar module 100 includes a thermistor, the plurality of electric wires may have detection wires connected to the thermistor.

The connector 130 is connected to the terminal of the wire harness 2 and is fitted to a monitoring unit 230. The monitoring unit 230 can be fixed to the first surface 210a of the battery module 210. For example, the monitoring unit 230 is attachable/detachable with respect to the first surface 210a of battery module 210. The monitoring unit 230 may be fixed to the battery module 210 by, for example, a fastening member such as a bolt. In this case, the monitoring unit 230 can be separated from the battery module 210 by detaching the fastening member. The monitoring units 230 are arranged side by side with respect to the case 120 of the busbar module 100.

The connector 130 of the present embodiment is fitted to the fixed monitoring unit 230 along the first direction X. However, the fitting direction of the connector 130 with respect to the monitoring unit 230 is not limited to the first direction X.

In the present specification, a direction in which the case 120 and the monitoring unit 230 are arranged is referred to as an arrangement direction Z. The arrangement direction Z is orthogonal to the first direction X. The arrangement direction Z is, for example, a width direction in which electrodes are arranged in one battery cell 220. A direction orthogonal to both the first direction X and the arrangement direction Z is referred to as a second direction Y. The case 120 and the monitoring unit 230 face the battery module 210 in the second direction Y.

The monitoring unit 230 is a device that monitors the state of the battery module 210. The monitoring unit 230 is connected to the bus bar 110 and the thermistor via the wire harness 2. The monitoring unit 230 has a connector corresponding to the connector 130. The connector 130 of the busbar module 100 is inserted into the monitoring unit 230 and connected to the connector of the monitoring unit 230.

The wire harness 2 is routed while being curved in a substantially U-shape between the case 120 and the monitoring unit 230. The protector 3 is a protective member that protects the wire harness 2. As described below, the protector 3 of the present embodiment can protect the wire harness 2 while securing the degree of freedom of the routing position and the routing path of the wire harness 2.

As illustrated in FIG. 1, the protector 3 includes a first protector 10, a second protector 20, and a guide member 30. The wire harness 2 includes a protecting portion 4 and an exposed portion 5. The protecting portion 4 is a portion protected by the protector 3. The exposed portion 5 is a portion projecting out from the protector 3 and exposed to the external space.

The protecting portion 4 has a first portion 41 and a second portion 42. The first portion 41 is a portion that is accommodated in the first protector 10 of the protector 3 and protected by the first protector 10. The second portion 42 is a portion that is accommodated in the second protector 20 of the protector 3 and protected by the second protector 20.

The exposed portion 5 includes a first exposed portion 51, a second exposed portion 52, and a third exposed portion 53. The first exposed portion 51 projects out from the first protector 10 toward the bus bar 110. The first exposed portion 51 is a portion of the wire harness 2 extending between the first protector 10 and the case 120. The second exposed portion 52 projects out from the second protector 20 toward the connector 130. The second exposed portion 52 is a portion extending between the second protector 20 and the connector 130. The third exposed portion 53 is exposed to the external space between the first protector 10 and the second protector 20. The third exposed portion 53 extends from the first protector 10 to the second protector 20 while being curved in a substantially U-shape.

The first protector 10 and the second protector 20 are molded from, for example, synthetic resin having insulating property. The first protector 10 is formed in a tubular shape. The illustrated shape of the first protector 10 is a square tube shape. The outer side surface of the first protector 10 has two protrusions 11. The two protrusions 11 are arranged side by side along the axial direction of the first protector 10. The shape of the protrusion 11 is, for example, a circular column shape with a widened-width distal end.

The second protector 20 is formed in a tubular shape. The illustrated shape of the second protector 20 is a square tube shape. The outer side surface of the second protector 20 has one protrusion 21. The shape of the protrusion 21 is, for example, a circular column shape with a widened-width distal end.

The guide member 30 is formed of, for example, synthetic resin or metal. The guide member 30 includes a main body 31, two engagement holes 32, one guide hole 33, and an engagement portion 34. The main body 31 has a flat plate shape. The shape of the main body 31 in plan view is, for example, a rectangle.

The engagement hole 32 and the guide hole 33 are through holes penetrating the main body 31. The engagement hole 32 corresponds to the protrusion 11 of the first protector 10. The engagement hole 32 is disposed at an end portion in the longitudinal direction of the main body 31. The two engagement holes 32 are arranged side by side in a direction orthogonal to the longitudinal direction of the main body 31. The shape of the engagement hole 32 is, for example, a circular shape. The guide hole 33 is a long hole extending in the longitudinal direction of the main body 31. The guide hole 33 guides the protrusion 21 of the second protector 20.

The engagement portion 34 engages with a wall portion or the like of the device. For example, the engagement portion 34 is fitted into a recess provided in the housing of the battery pack 200. The engagement portion 34 is disposed at an end portion on a side opposite to the side of the engagement hole 32 in the main body 31. The guide hole 33 extends between the engagement portion 34 and the engagement hole 32.

As illustrated in FIG. 1, a portion of the wire harness 2 between the case 120 and the connector 130 is inserted into the first protector 10 and the second protector 20. The second protector 20 is disposed on the side of the connector 130 with respect to the first protector 10. In other words, the second portion 42 protected by the second protector 20 is a portion closer to the connector 130 than the first portion 41 protected by the first protector 10. The two protrusions 11 of the first protector 10 are inserted into the corresponding engagement holes 32 of the guide member 30. When the two protrusions 11 are fitted into the two engagement holes 32, the first protector 10 is fixed to the guide member 30.

The protrusion 21 of the second protector 20 is inserted into the guide hole 33 of the guide member 30 and guided by the guide hole 33. The guide member 30 assembled to the two protectors 10 and 20 is connected to the wall portion or the like by the engagement portion 34. The engagement portion 34 may be supported by a wall portion or the like such that the main body 31 is swingable.

The first protector 10 and the second protector 20 of the present embodiment are disposed on the second surface 210b of the battery module 210. The second surface 210b is a surface different from the first surface 210a and orthogonal to the first surface 210a. The second surface 210b is, for example, an end face of the battery module 210 in the first direction X.

The first protector 10 and the second protector 20 are extended in the second direction Y along the second surface 210b. In addition, the two protectors 10 and 20 are arranged side by side in the arrangement direction Z. The first exposed portion 51 projects out from the first protector 10 toward the second direction Y. The second exposed portion 52 projects out from the second protector 20 toward the second direction Y. The first exposed portion 51 and the second exposed portion 52 are arranged in the arrangement direction Z and face each other in the arrangement direction Z. That is, the protector 3 accommodates the protecting portion 4 such that the first exposed portion 51 and the second exposed portion 52 are extended side by side.

The first exposed portion 51 is routed while being curved at a corner portion where the first surface 210a and the second surface 210b intersect each other. The second exposed portion 52 is routed while being curved at the corner portion.

As illustrated in FIG. 2, the first protector 10 is held by the guide member 30. The first protector 10 is fixed at a predetermined position in the arrangement direction Z. The second protector 20 can be moved in the arrangement direction Z while being guided by the guide member 30. The second protector 20 moves relative to the first protector 10 while sliding the protrusion 21 along the guide hole 33. The guide hole 33 can move the protrusions 21 to the first side Z1 in the arrangement direction Z and can move the protrusions 21 to the second side Z2 in the arrangement direction Z. The first side Z1 is a side on which the second protector 20 moves away from the first protector 10. The second side Z2 is a side on which the second protector 20 moves closer to the first protector 10.

The movement of the second protector 20 changes the distance Dt between the first exposed portion 51 and the second exposed portion 52. That is, the protector 3 is configured to be able to change the distance Dt between the first exposed portion 51 and the second exposed portion 52.

Since the distance Dt is variable, the wire harness 2 can change the routing position and the routing path according to the position of the connector 130 in the arrangement direction Z. For example, the protector 3 can correspond to the plurality of battery modules 210 having different relative positions of the monitoring unit 230 with respect to the case 120 in the arrangement direction Z. That is, according to the routing structure 1 of the wire harness according to the present embodiment, even when the relative position of the monitoring unit 230 with respect to the case 120 is different in the arrangement direction Z, the connector 130 can be fitted to the monitoring unit 230.

In addition, according to the routing structure 1 of the wire harness according to the present embodiment, the connector 130 can be fitted to the monitoring unit 230 that is not fixed to the battery module 210. For example, it is possible to fix the monitoring unit 230 to the battery module 210 after the connector 130 is fitted to the monitoring unit 230. The routing structure 1 of the wire harness may be configured, for example, such that the connector 130 can be fitted to the monitoring unit 230 at outside the battery pack 200.

The movable range of the second exposed portion 52 in the arrangement direction Z can be set according to the length and position of the guide hole 33. The length of the third exposed portion 53 may include an extra length that allows the second protector 20 to move along the guide hole 33.

FIG. 3 illustrates another protector 3 according to the embodiment. The protector 3 of FIG. 3 has an accommodating portion 60 instead of the guide member 30 of the protector 3 of FIG. 1. The accommodating portion 60 in FIG. 3 is a groove member having a groove shape. The accommodating portion 60 allows the first protector 10 and the second protector 20 to relatively move along the arrangement direction Z.

The accommodating portion 60 has a first side wall 61, a second side wall 62, and a bottom wall 63. The first side wall 61 and the second side wall 62 face each other in the first direction X. In the first side wall 61, an opposing surface facing the second side wall 62 is preferably a plane. In the second side wall 62, an opposing surface facing the first side wall 61 is preferably a plane. The two opposing surfaces are preferably parallel.

The first side wall 61 is disposed on the second surface 210b of battery module 210. The second side wall 62 is disposed at a distance with respect to the first side wall 61. The size of the gap between the first side wall 61 and the second side wall 62 is a size that allows the first protector 10 and the second protector 20 to face each other in the arrangement direction Z and allows the relative movement of the two protectors 10 and 20.

The bottom wall 63 connects end portions of the first side wall 61 and the second side wall 62 on the second side Z2. An end portion of the accommodating portion 60 on the first side Z1 is opened toward the first side Z1. That is, the first side wall 61, the second side wall 62, and the bottom wall 63 form a substantially U-shaped groove opened toward the first side z1.

The first protector 10 and the second protector 20 are accommodated in the accommodation space 64 between the first side wall 61 and the second side wall 62. The first protector 10 and the second protector 20 are formed in a tubular shape. The shape of the two protectors 10 and 20 is, for example, a square tube shape. In this case, the first protector 10 and the second protector 20 have one side surface facing the first side wall 61 and the other side surface facing the second side wall 62. A slight gap is provided between the two protectors 10 and 20 and the two side walls 61 and 62. The two protectors 10 and 20 can move in the arrangement direction Z while slidably moving with respect to the two side walls 61 and 62.

In the protector 3 of FIG. 3, the first protector 10 does not have the protrusion 11, and the second protector 20 does not have the protrusion 21. In the two protectors 10 and 20, the opposing surface facing the side walls 61 and 62 may be a plane. The opposing surfaces of the protectors 10 and 20 may have ribs that reduce contact areas with the side walls 61 and 62. The side walls 61 and 62 may have ribs that reduce contact areas with the protectors 10 and 20. The side walls 61 and 62 may have ribs that guide the protectors 10 and 20. In this case, the guide ribs may be extended in the arrangement direction Z.

The first protector 10 and the second protector 20 are extended in the second direction Y, and are accommodated in the accommodating portion 60 while being arranged side by side in the arrangement direction Z. The first protector 10 accommodates the first portion 41 of the protecting portion 4. The second protector 20 accommodates the second portion 42 of the protecting portion 4. The first exposed portion 51 projects out from the first protector 10 toward the second direction Y. The second exposed portion 52 projects out from the second protector 20 toward the second direction Y. The first exposed portion 51 and the second exposed portion 52 are arranged side by side in the arrangement direction Z and face each other in the arrangement direction Z. That is, the protector 3 of FIG. 3 has the first exposed portion 51 and the second exposed portion 52 extended side by side.

The bottom wall 63 can support the first protector 10. For example, when the arrangement direction Z is the up-down direction and the second side Z2 is the lower side, the bottom wall 63 can support the first protector 10 from below.

The first protector 10 and the second protector 20 are movable in the arrangement direction Z inside the accommodating portion 60. The first side wall 61 and the second side wall 62 guide the protectors 10 and 20 and allow the protectors 10 and 20 to move along the arrangement direction Z. Therefore, the protector 3 in FIG. 3 is configured to be able to change the distance Dt between the first exposed portion 51 and the second exposed portion 52. Since the two protectors 10 and 20 are movable in the arrangement direction Z, the connector 130 has high followability with respect to the monitoring unit 230.

FIG. 4 illustrates another protector 3 according to the embodiment. The protector 3 in FIG. 4 includes a protector main body 71 and a cover 72. The protector main body 71 is disposed on the second surface 210b of the battery module 210. The monitoring unit 230 and the case 120 are disposed on the first surface 210a of the battery module 210. The protector main body 71 has a bottom wall 73, a first side wall 74a, a second side wall 74b, a third side wall 74c, and a partition wall 75. The shape of the bottom wall 73 illustrated in FIG. 4 is substantially rectangular.

The first side wall 74a, the second side wall 74b, and the third side wall 74c are provided in an upright state toward the first direction X from the edge portion of the bottom wall 73. The first side wall 74a and the second side wall 74b face each other in the arrangement direction Z. The third side wall 74c connects the end portions of the first side wall 74a and the second side wall 74b in the second direction Y, and extends in the arrangement direction Z. The bottom wall 73 and the three side walls 74a, 74b, and 74c form an accommodation space 77 that accommodates the protecting portion 4.

Each of the side walls 74a, 74b, and 74c is provided with an engagement portion 76. The partition wall 75 projects out from the bottom wall 73 toward the first direction X and extends in the second direction Y. A gap through which the protecting portion 4 can pass is provided between the end portion of the partition wall 75 and the third side wall 74c. The partition wall 75 partitions the inside of the accommodation space 77 into a first space portion 77a and a second space portion 77b. The first space portion 77a is a space portion on the second side Z2 with respect to the partition wall 75. The second space portion 77b is a space portion on the first side Z1 with respect to the partition wall 75.

The protecting portion 4 is accommodated in the accommodation space 77 while being curved in a substantially U-shape so as to go around along the partition wall 75. The protecting portion 4 has a first extending portion 43 and a second extending portion 44. The first extending portion 43 is a portion extending to the first space portion 77a. The second extending portion 44 is a portion extending to the second space portion 77b. In the arrangement direction Z, the width of the second space portion 77b is wider than the width of the first space portion 77a. That is, the movable range of the second extending portion 44 in the arrangement direction Z is wider than the movable range of the first extending portion 43.

The cover 72 engages with the protector main body 71 along the first direction X to cover the accommodation space 77. The cover 72 has a plate shape, covers the accommodation space 77 from the first direction X and faces the bottom wall 73. The edge portion of the cover 72 is provided with a plurality of engagement portions 78. The engagement portion 78 engages with the engagement portion 76 of the protector main body 71.

The first exposed portion 51 projects out from the first space portion 77a toward the second direction Y. That is, the first exposed portion 51 extends between the first extending portion 43 and the case 120. The second exposed portion 52 projects out from the second space portion 77b toward the second direction Y. That is, the second exposed portion 52 extends between the second extending portion 44 and the connector 130. The first exposed portion 51 and the second exposed portion 52 are arranged in the arrangement direction Z and face each other in the arrangement direction Z. That is, the protector 3 of FIG. 4 accommodates the protecting portion 4 such that the first exposed portion 51 and the second exposed portion 52 are extended side by side.

The protector 3 of FIG. 4 allows the protecting portion 4 to deform in the accommodation space 77. For example, the protector 3 allows the protecting portion 4 to deform in the accommodation space 77 so as to follow a change in the distance Dt between the first exposed portion 51 and the second exposed portion 52. The distance Dt between the two exposed portions 51 and 52 changes, for example, when the connector 130 is fitted to the monitoring unit 230. The protector 3 of FIG. 4 can allow deformation of the wire harness 2 so that the connector 130 can be fitted to the monitoring unit 230 having different positions in the arrangement direction Z.

Furthermore, according to the protector 3 of FIG. 4, the monitoring unit 230 can be fixed to the battery module 210 after the connector 130 is fitted to the monitoring unit 230. For example, the protector 3 may be configured such that the connector 130 can be fitted to the monitoring unit 230 at outside the battery pack 200.

FIG. 5 illustrates another protector 3 according to the embodiment. The protector 3 in FIG. 5 includes a protector main body 81 and a cover 82. The protector main body 81 is disposed on the second surface 210b of the battery module 210. The monitoring unit 230 and the case 120 are disposed on the first surface 210a of the battery module 210. The protector main body 81 has a bottom wall 83, a first side wall 84a, a second side wall 84b, and a third side wall 84c. The bottom wall 83 illustrated in FIG. 5 has a tapered shape. More specifically, the shape of the bottom wall 83 in plan view is a tapered shape in which the opening through which the two exposed portions 51 and 52 project out has the widest width. The shape of the bottom wall 83 is, for example, a substantially V-shape.

The first side wall 84a, the second side wall 84b, and the third side wall 84c are provided in an upright state toward the first direction X from the edge portion of the bottom wall 83. The first side wall 84a and the second side wall 84b face each other in the arrangement direction Z. The third side wall 84c connects the end portions of the first side wall 84a and the second side wall 84b in the second direction Y, and extends in the arrangement direction Z. The bottom wall 83 and the three side walls 84a, 84b, and 84c form an accommodation space 87 that accommodates the protecting portion 4. The distance between the two side walls 84a and 84b becomes wider farther away from the third side wall 84c along the second direction Y. Each of the side walls 84a, 84b, and 84c is provided with an engagement portion 86.

The protecting portion 4 is accommodated in the accommodation space 87 while being curved in a substantially U-shape or being bent in a substantially V-shape. When the wire harness 2 is formed of a plurality of electric wires, the protecting portion 4 may be accommodated in the accommodation space 87 while being curved in a substantially U-shape. The wire harness 2 illustrated in FIG. 5 is a flat routing material such as a flexible printed wiring board. The flat routing material may be accommodated in the accommodation space 87 while being bent in a substantially V-shape.

In the wire harness 2 of FIG. 5, the protecting portion 4 includes a first bent portion 45 and a second bent portion 46. The first bent portion 45 is a bent portion on a side closer to the first exposed portion 51 of the two bent portions 45 and 46. The second bent portion 46 is a bent portion on a side closer to the second exposed portion 52 of the two bent portions 45 and 46.

The cover 82 engages with the protector main body 81 along the first direction X to cover the accommodation space 87. The cover 82 has a plate shape, covers the accommodation space 87 from the first direction X and faces the bottom wall 83. The edge portion of the cover 82 is provided with a plurality of engagement portions 88. The engagement portion 88 engages with the engagement portion 86 of the protector main body 81.

The first exposed portion 51 and the second exposed portion 52 project out from the accommodation space 87 toward the second direction Y. The first exposed portion 51 and the second exposed portion 52 are arranged in the arrangement direction Z and face each other in the arrangement direction Z. That is, the protector 3 of FIG. 5 accommodates the protecting portion 4 such that the first exposed portion 51 and the second exposed portion 52 are extended side by side.

The protector 3 of FIG. 5 allows the protecting portion 4 to deform in the accommodation space 87. For example, the protector 3 allows the protecting portion 4 to deform in the accommodation space 87 so as to follow a change in the distance Dt between the first exposed portion 51 and the second exposed portion 52. FIG. 6 illustrates deformation of the second bent portion 46. The second bent portion 46 is folded back between the first portion 46a and the second portion 46b. The first portion 46a is a portion connected to the first bent portion 45. The second portion 46b is a portion connected to the second exposed portion 52.

The protecting portion 4 deforms such that the angle θ of the second bent portion 46 increases or decreases. The angle θ is an angle formed by the extending direction of the first portion 46a and the extending direction of the second portion 46b. The left side of FIG. 6 illustrates the second bent portion 46 when the angle θ is a relatively small value 01, and the right side of FIG. 6 illustrates the second bent portion 46 when the angle θ is a relatively large value 02.

When the second exposed portion 52 approaches the first exposed portion 51 along the arrangement direction Z, the protecting portion 4 deforms such that the angle θ decreases. On the other hand, when the second exposed portion 52 moves away from the first exposed portion 51 along the arrangement direction Z, the protecting portion 4 deforms such that the angle θ increases.

Furthermore, the protecting portion 4 can also change the distance between the two bent portions 45 and 46 when the distance Dt between the first exposed portion 51 and the second exposed portion 52 is increased or decreased. For example, when the second exposed portion 52 approaches the first exposed portion 51 along the arrangement direction Z, the protecting portion 4 may deform to widen the distance between the two bent portions 45 and 46. For example, when the second exposed portion 52 moves away from the first exposed portion 51 along the arrangement direction Z, the protecting portion 4 may deform to narrow the distance between the two bent portions 45 and 46.

As described above, the protector 3 in FIG. 5 allows the protecting portion 4 to deform in the accommodation space 87 so as to follow the change in the distance Dt between the first exposed portion 51 and the second exposed portion 52. The distance Dt between the two exposed portions 51 and 52 changes, for example, when the connector 130 is fitted to the monitoring unit 230. The protector 3 of FIG. 5 can allow deformation of the wire harness 2 so that the connector 130 can be fitted to the monitoring unit 230 having different positions in the arrangement direction Z.

Furthermore, according to the protector 3 of FIG. 5, the monitoring unit 230 can be fixed to the battery module 210 after the connector 130 is fitted to the monitoring unit 230. The routing structure 1 of the wire harness may be configured, for example, such that the connector 130 can be fitted to the monitoring unit 230 at outside the battery pack 200.

As described above, the wire harness routing structure 1 of the present embodiment includes the wire harness 2 and the protector 3. The wire harness 2 includes a detection wire W1 connecting the bus bar 110 and the connector 130. The wire harness 2 includes the protecting portion 4 protected by the protector 3, the first exposed portion 51, and the second exposed portion 52. The first exposed portion 51 projects out from the protector 3 toward the bus bar 110. The second exposed portion 52 projects out from the protector 3 toward the connector 130.

That is, the protector 3 accommodates the protecting portion 4 such that the first exposed portion 51 and the second exposed portion 52 are extended side by side. That is, the protector 3 is configured to be able to change the distance Dt between the first exposed portion 51 and the second exposed portion 52. The wire harness routing structure 1 according to the present embodiment can change the distance Dt between the first exposed portion 51 and the second exposed portion 52, and can improve workability when fitting the connector 130 to the mating connector.

The protector 3 in FIG. 1 includes a first protector 10, a second protector 20, and a guide member 30. The first protector 10 accommodates a portion of the protecting portion 4 connected to the first exposed portion 51. The second protector 20 accommodates a portion of the protecting portion 4 connected to the second exposed portion 52. The guide member 30 guides the first protector 10 and the second protector 20 such that the first protector 10 and the second protector 20 are relatively movable in the arrangement direction Z. With such a configuration, it is possible to control the trajectory along which the two protectors 10 and 20 relatively move.

The protector 3 in FIG. 3 includes the first protector 10, the second protector 20, and the accommodating portion 60. The first protector 10 accommodates a portion of the protecting portion 4 connected to the first exposed portion 51. The second protector 20 accommodates a portion of the protecting portion 4 connected to the second exposed portion 52. The accommodating portion 60 accommodates the first protector 10 and the second protector 20 so as to allow relative movement between the first protector 10 and the second protector 20 in the arrangement direction z.

The protector 3 of FIG. 4 includes the accommodation space 77 that accommodates the protecting portion 4. The protector 3 allows the protecting portion 4 to deform in the accommodation space 77 so as to follow a change in the distance Dt between the first exposed portion 51 and the second exposed portion 52. Similarly, the protector 3 of FIG. 5 includes the accommodation space 87 that accommodates the protecting portion 4. The protector 3 allows the protecting portion 4 to deform in the accommodation space 87 so as to follow a change in the distance Dt between the first exposed portion 51 and the second exposed portion 52. Since the protecting portion 4 deforms inside the accommodation spaces 77 and 87, the wire harness 2 is less likely to interfere with peripheral components.

The shape of the protecting portion 4 in the accommodation spaces 77 and 78 is not limited to a U-shape or a V-shape. The protecting portion 4 may have, for example, a meandering shape having a plurality of curved portions, or may have other shapes. The protecting portion 4 may have a plurality of turn portions in the accommodation spaces 77 and 78. The extending direction of the protecting portion 4 changes at each turn portion. Each of the turn portions may have a U-shape or a V-shape.

The contents disclosed in the above embodiment can be appropriately combined and executed.

In a routing structure of a wire harness according to the present embodiment, a protector is configured to accommodate a protecting portion so as to extend a first exposed portion and a second exposed portion of the wire harness side by side, and to allow a distance between the first exposed portion and the second exposed portion to be changed. According to the routing structure of the wire harness according to the present embodiment, an effect that the workability of the fitting work can be improved is obtained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure of a wire harness comprising:
a wire harness including a detection wire connecting a bus bar and a connector; and
a protector, wherein
the wire harness includes a protecting portion protected by the protector, a first exposed portion, and a second exposed portion,
the first exposed portion projects out from the protector toward the bus bar,
the second exposed portion projects out from the protector toward the connector, and
the protector is configured to accommodate the protecting portion so as to extend the first exposed portion and the second exposed portion side by side, and to change a distance between the first exposed portion and the second exposed portion.

2. The routing structure of the wire harness according to claim 1, wherein
the protector includes a first protector that accommodates a portion of the protecting portion connected to the first exposed portion, a second protector that accommodates a portion of the protecting portion connected to the second exposed portion, and a guide member, and
the guide member guides the first protector and the second protector such that the first protector and the second protector are relatively movable in an arrangement direction in which the first exposed portion and the second exposed portion are arranged side by side.

3. The routing structure of the wire harness according to claim 1, wherein
the protector includes a first protector that accommodates a portion of the protecting portion connected to the first exposed portion, a second protector that accommodates a portion of the protecting portion connected to the second exposed portion, and an accommodating portion, and
the accommodating portion accommodates the first protector and the second protector to allow relative movement of the first protector and the second protector in an arrangement direction in which the first exposed portion and the second exposed portion are arranged side by side.

4. The routing structure of the wire harness according to claim 1, wherein
the protector has an accommodation space that accommodates the protecting portion, and
the protector allows the protecting portion to deform in the accommodation space to follow a change in a distance between the first exposed portion and the second exposed portion.
